(19) United States
(12) Patent Application Publication
(10) Pub. No.: US 2018/0038363 A1
(43) Pub. Date: Feb. 8, 2018

(54) DOUBLE DIAPHRAGM PUMPS WITH AN ELECTROMAGNETIC DRIVE

(71) Applicant: James Ernest TRETHEWEY, Waterloo (CA)

(72) Inventor: James Ernest TRETHEWEY, Waterloo (CA)

(73) Assignee: Jet Fluid Systems Inc.

(21) Appl. No.: 15/231,252

(22) Filed: Aug. 8, 2016

(51) Int. Cl. F04B 43/04; H02K 33/12; F04B 53/10; F04B 43/02; F04B 53/16

(52) U.S. Cl. CPC F04B 43/04; F04B 43/026; F04B 53/16; F04B 53/10; H02K 33/12

(57) ABSTRACT

A double diaphragm pump has an electromagnetic drive mechanism in which an electromagnetic coil is located between two permanents magnets of like polarity that are alternately attracted to the electromagnetic coil as the polarity of the electromagnetic coil changes. The electromagnetic coil and the permanent magnets are located within a piston assembly that is caused to reciprocate via the change in polarity of the electromagnetic coil. In a second embodiment, there are a plurality of electromagnetic coils arranged in two adjacent rows that surround a shaft with a set of a plurality of permanent magnets located between each pair of electromagnetic coils.

### FIELD OF THE INVENTION

This invention relates to a double diaphragm pump for pumping liquids, the pump being driven by a combination of electromagnetic coils and permanent magnets or, alternatively, a combination of electromagnetic coils, some of which function as permanent magnets.

### DESCRIPTION OF THE PRIOR ART

Double diaphragm pumps are known and these pumps can have a single manifold or dual manifold porting. The drive mechanism of previous double diaphragm pumps is pneumatic, mechanical or electromechanical.

### SUMMARY OF INVENTION

A double diaphragm pump comprises a shaft assembly located in a housing, the shaft assembly having a shaft with two ends and two diaphragms, there being one diaphragm at each end. A pumping chamber is located outside of each diaphragm, there being two pumping chambers. The pumping chambers are fluidly connected to one another and each pumping chamber has at least one opening to receive and discharge pumpage. The shaft assembly is slidable from side to side of the pump from one pumping chamber to the other. A first electromagnetic coil is fixedly mounted within the housing and is located within a piston assembly between two additional magnets. During operation, the additional magnets are oriented with like polarity facing the first electromagnetic coil is the additional magnets being affixed to the piston assembly. One of the additional magnets is always spaced-apart from the first electromagnetic coil. Buffer fluid fills a void in the housing between the shaft assembly and the piston assembly, the piston assembly being sealed to prevent buffer fluid from contacting the first electromagnetic coil and the additional magnets. The first electromagnetic coil is connected to repeatedly reverse polarity to alternately attract one additional magnet and repel the other additional magnet to cause the piston assembly to reciprocate with the additional magnets as the first electromagnetic coil remains fixed. The reciprocation of the piston assembly exerts pressure on the buffer fluid to cause the shaft assembly to reciprocate, the shaft assembly alternately exerting pressure on one pumping chamber while releasing pressure on the other pumping chamber, with check valves, seals and inlet/discharge ports to facilitate pumping action.

A double diaphragm pump for pumping liquids, the pump comprising a shaft assembly mounted in a housing. The shaft assembly has a shaft with two ends and two diaphragms, there being one diaphragm mounted at each end of the two ends of the shaft. Two pumping chambers are located within the housing outside of each diaphragm and a piston assembly surrounds the shaft, the shaft assembly being slidabie between the two pumping chambers and the piston assembly being slidabie in the same direction as the shaft assembly. Two rows of a plurality of electromagnetic coils surround the shaft, the two rows being spaced apart from one another and being parallel to one another with each electromagnetic coil in one row being adjacent to an electromagnetic coil in the other row. The adjacent electromagnetic cons in the two rows each form a pair of electromagnetic coils; the electromagnetic coils located within each row being spaced-apart from one another. A plurality of sets of permanent magnets surrounding said shaft, each set having a plurality of permanent magnets that are slightly spaced apart from one another. Each permanent magnet of the plurality of permanent magnets of each set being arranged so that adjacent permanent magnets within each set have opposing polarity and the plurality of permanent magnets in alternating sets have opposing polarity to each adjacent set. There is one set of permanent magnets located between each pair of electromagnetic coils. The two rows of electromagnetic cons are fixedly mounted on one of the housing and the piston assembly and the plurality of sets of permanent magnets are fixedly mounted on another of the piston assembly and the housing respectively. A void between the shaft assembly and the piston assembly is filled with buffer fluid, the electromagnetic coils being connected to alternate polarity. The alternating polarity of the electromagnetic coils causes the sets to simultaneously move longitudinally relative to the electromagnetic coils in one direction for one stroke and in an opposite direction for one stroke, thereby causing the piston assembly to reciprocate within the housing between the two pumping chambers. The reciprocating piston assembly is located to exert pressure on the buffer fluid, which in turn causes the shaft assembly to reciprocate between the pumping chambers and there are inlet/discharge ports and check valves to facilitate pumping action.

A double diaphragm pump for pumping liquids, the pump comprising a shaft assembly mounted in a housing, the shaft assembly having a shaft with two ends and two diaphragms, there being one diaphragm mounted at each end of the two ends of the shaft. Two pumping chambers are located within the housing outside of each diaphragm. A piston assembly surrounds the shaft, the shaft assembly being slidable between the two pumping chambers and the piston assembly being slidable in the same direction as the shaft assembly. A void between the shaft assembly and the piston assembly is filled with buffer fluid. A combination of electromagnetic coils and permanent magnets are arranged to form a tubular linear motor that is connected to a power source to cause the electromagnetic cons to repeatedly alternate polarity to cause the piston assembly to reciprocate within the housing between the two pumping chambers. The reciprocating piston assembly exerts pressure on the buffer fluid, which in turn causes the shaft assembly to reciprocate; there are inlet/discharge ports and check valves to facilitate pumping action.

A double diaphragm pump for pumping liquids, the pump comprising:
(a) a shaft assembly mounted in a housing, the shaft assembly having a shaft with two ends and two diaphragms, there being one diaphragm mounted at each end of the two ends of the shaft;
(b) two pumping chambers located within the housing outside of each diaphragm;
(c) a piston assembly surrounding the shaft, the shaft assembly being slidable between the two pumping chambers and the piston assembly being slidable in the same direction as the shaft assembly;
(d) two rows of a plurality of electromagnetic coils surrounding the shaft, the two rows being spaced apart from one another and being parallel to one another with each electromagnetic coil in one row being adjacent to an electromagnetic coil in the other row, the adjacent electromagnetic cons in the two rows forming a pair of electromagnetic cons;
(e) a plurality of sets of permanent magnets surrounding said shaft, each set having a plurality of permanent magnets that are slightly spaced apart from one another;
(f) each permanent magnet of the plurality of permanent magnets of each set being arranged so that adjacent permanent magnets within each set have opposing polarity and the plurality of permanent magnets in alternating sets have opposing polarity to each adjacent set, there being one set of permanent magnets located between each pair of electromagnetic coils;
(g) the two rows of electromagnetic coils being fixedly mounted on one of the housing and the piston assembly and the plurality of sets of permanent magnets being fixedly mounted on another of the piston assembly and the housing respectively;
(h) a void between the shaft assembly and the piston assembly being filled with buffer fluid;
(i) the electromagnetic coils being connected to alternating polarity voltage, the alternating polarity voltage of the electromagnetic coils causing the sets to simultaneously move longitudinally relative to the electromagnetic coils in one direction for one stroke and in an opposite direction for one stroke, thereby causing the shaft assembly to reciprocate;
(j) the reciprocating piston assembly being located to exert pressure on the buffer fluid, which in turn causes the shaft assembly to reciprocate between the pumping chambers; and
(k) inlet/discharge ports and check valves to facilitate pumping action.

A double diaphragm pump for pumping liquids, the pump comprising:
(a) a shaft assembly mounted in a housing, the shaft assembly having a shaft with two ends and two diaphragms, there being one diaphragm mounted at each end of the two ends of the shaft;
(b) two pumping chambers located within the housing outside of each diaphragm;
(c) a piston assembly surrounding the shaft, the shaft assembly being slidable between the two pumping chambers and the piston assembly being slidabie in the same direction as the shaft assembly;
(d) two rows of a plurality of first electromagnetic coils surrounding the shaft, the two rows being spaced apart from one another and being parallel to one another with each electromagnetic coil in one row being adjacent to an electromagnetic coil in the other row, the adjacent electromagnetic coils in the two rows forming a pair of electromagnetic coils;
(e) a plurality of sets of second electromagnetic coils surrounding said shaft, each set having a plurality of second electromagnetic coils that are slightly spaced apart from one another;
(f) each permanent magnet of the plurality of second electromagnetic coils of each set being arranged so that adjacent second electromagnetic coils within each set have opposing polarity and the plurality of second electromagnetic coils in alternating sets have opposing polarity to each adjacent set, there being one set of second electromagnetic coils located between each pair of first electromagnetic coils;
(g) the two rows of first electromagnetic coils being fixedly mounted on one of the housing and the piston assembly and the plurality of sets of second electromagnetic coils being fixedly mounted on another of the piston assembly and the housing respectively;
(h) a void between the shaft assembly and the piston assembly being filled with buffer fluid;
(i) the first electromagnetic coils being connected to alternating polarity voltage, the alternating polarity voltage of the first electromagnetic coils causing the sets to simultaneously move longitudinally relative to the first electromagnetic coils in one direction for one stroke and in an opposite direction for one stroke, thereby causing the piston assembly to reciprocate within the housing between the two pumping chambers;
(j) the reciprocating piston assembly being located to exert pressure on the buffer fluid, which in turn causes the shaft assembly to reciprocate between the pumping chambers; and
(k) inlet/discharge ports and check valves to facilitate pumping action.

A method of operating a double diaphragm pump for pumping liquids, the pump having:
(a) a shaft assembly mounted in a housing, the shaft assembly having a shaft with two ends and two diaphragms, there being one diaphragm mounted at each end of the two ends of the shaft;
(b) two pumping chambers located within the housing outside of each diaphragm;
(c) a piston assembly surrounding the shaft, the shaft assembly being slidable between the two pumping chambers and the piston assembly being slidable in the same direction as the shaft assembly;
(d) a void between the shaft assembly and the piston assembly being filled with buffer fluid;
(e) a combination of electromagnetic coils and permanent magnets arranged to form a tubular linear motor that is connected to a power source to cause the electromagnetic coils to repeatedly alternate polarity to cause the piston assembly to reciprocate within the housing between the two pumping chambers;
(f) the reciprocating piston assembly exerting pressure on the buffer fluid, which in turn causes the shaft assembly to reciprocate;
(g) inlet/discharge ports and check valves to facilitate pumping action;
(h) the method comprising connecting the tubular linear motor to a power source to cause the electromagnetic coils to repeatedly alternate polarity, thereby causing some of the permanent magnetics to be alternately attracted and repelled by the electromagnetic coils and causing the piston assembly to reciprocate within the housing between the two pumping chambers, the piston assembly in turn causing the buffer fluid to cause the shaft assembly to reciprocate.

### BRIEF DESCRIPTION OF THE DRAWINGS

FIG. 1 is a schematic cross-sectional view of a first embodiment of a double diaphragm pump having an electromagnetic coil affixed to a housing and permanent magnets on either side of the electromagnetic coil mounted to a piston assembly, with a drive mechanism shifted to the left;

FIG. 2 is a schematic sectional view of the first embodiment of a double diaphragm pump as shown in FIG. 1 with the drive mechanism shifted to the right;

FIG. 3 is a schematic sectional side view of a second embodiment of a double diaphragm pump having a tubular linear motor drive, a drive portion, excluding suction and discharge manifolds, along the Section A-A of FIG. 4;

FIG. 4 is a schematic sectional view of the drive portion of the second embodiment of the pump; and

FIG. 5 is a schematic top view of sets of a plurality of permanent magnets located between electromagnetic coils of a tubular linear motor drive system of the second embodiment;

### DETAILED DESCRIPTION OF THE PREFERRED EMBODIMENT

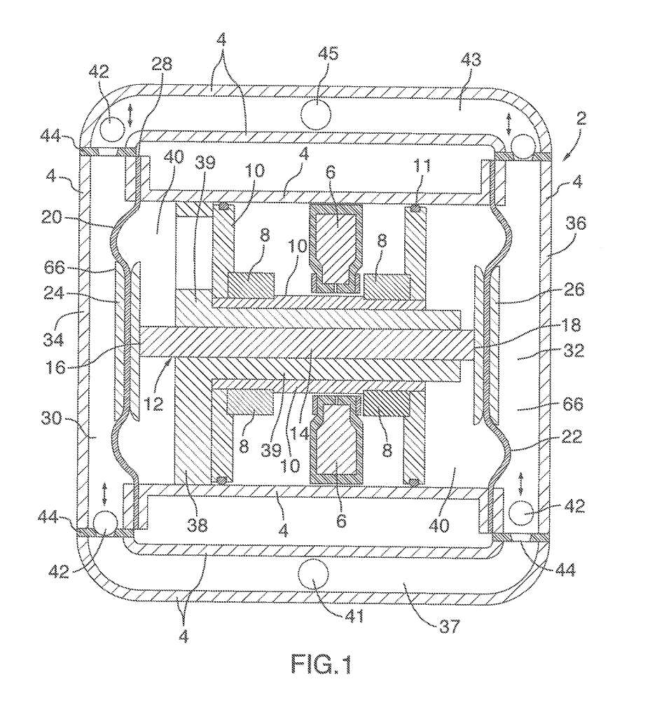

In FIG. 1, there is shown a first embodiment of a double diaphragm pump 2 having a housing 4 with an electromagnetic coil 6 that is located between two permanent magnets 8. The electromagnetic coil 6 is preferably affixed to an interior of the housing 4 and the permanent magnets are preferably affixed to a piston assembly 10. The piston assembly 10 is movable relative to the housing 4. O-rings 11 are located between the piston assembly 10 and the housing 4 to prevent buffer fluid from contacting the electromagnetic coil 6.

A shaft assembly 12 has a shaft 14 with two ends 16,18. There are two diaphragms 20,22, one diaphragm 20 being mounted at the end 16 of the shaft 14 and the other diaphragm 22 being mounted at the end 18 of shaft 14.

Preferably, there is a double disk 24 mounted at the end 16 and a double disk 26 mounted at the end 18. The two diaphragms 20,22 are held in place at the ends 16,18, respectively, by the double discs 24,26, respectively. An outer edge 28 of each of the diaphragms 20,22 is affixed to the housing 4. There are two pumping chambers 30,32 that are located immediately outside of the two diaphragms 20,22, respectively. Diaphragm covers 34,36 of the housing 4 are located outside the pumping chambers 30,32, respectively. The shaft 14 is slidably mounted in a shaft support 38 which is affixed to the housing 4. Preferably, the shaft support 38 is a sleeve 39 that surrounds the shaft 14. A void between the shaft support 38, the shaft assembly 12, the diaphragms 20,22, the piston assembly 10, and that part of the housing 4 between the diaphragms is filled with buffer fluid 40. The pumping chambers 30,32 have four check valve assemblies with balls 42 and seats 44. The check valves, seals and inlets/outlets of the pumps of the present invention may vary. The piston assemblies must be sealed so that the buffer fluid does not contact the electromagnetic coil. The electrical connections for the electromagnetic coil 6 are conventional and are not shown. The electromagnetic coil 6 can be connected to an alternating polarity voltage to cause the polarity of the coil to alternate. The permanent magnets 8 have like polarity facing the coil and are spaced apart from one another and at least one of the permanent magnets is always spaced apart from the electromagnetic coil. At the end of each stroke of the pump, one of the two permanent magnets is in contact with the electromagnetic con. The electromagnet 6 and the two permanent magnets 8 along with the piston assembly 10 preferably extend around the sleeve 39 of the shaft support 38.

In operation, as the polarity of the electromagnetic coil alternates, one of the permanent magnets is attracted to the electromagnetic cod, while the other permanent magnet is repelled. When the polarity of the electromagnetic coil changes, the opposite occurs causing the piston chamber to reciprocate between the two diaphragms. The reciprocation of the piston assembly in turn exerts alternating pressure on the buffer fluid, which in turn causes the shaft assembly and diaphragms to reciprocate, thereby alternately exerting pressure on one pumping chamber and then the other.

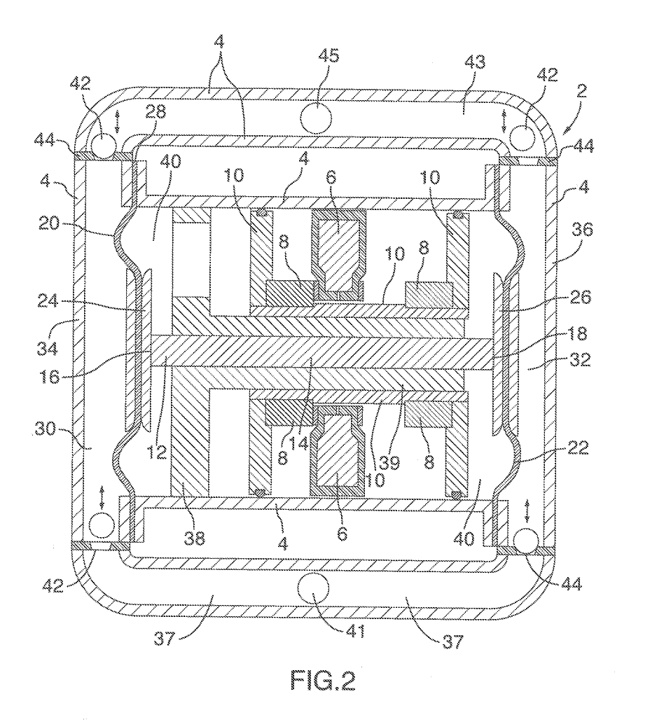

In FIG. 1, the piston assembly and the shaft assembly is shown to be closer to the pumping chamber 30 (i.e. the left side of the drawing) and further from the pumping chamber 32. In FIG. 2, the piston assembly and the shaft assembly are shown to be closer to the pumping chamber 32 (i.e. the right side of the drawing) and further from the pumping chamber 30. As the drive mechanism reciprocates, the piston assembly will move from side-to-side from first compressing one pumping chamber and then the other, as shown in FIGS. 1 and 2, respectively. The same reference numerals are used in FIG. 2 for those components that are identical to the components in FIG. 1. The electromagnetic cons of the first embodiment are preferably powered by DC voltage and DC current. The polarity of the electromagnetic coils is reversed at the end of each stroke. The pumping chambers 30, 32 are fluidly connected through passage 37, which contains pump inlet 41 and passage 43, which contains pump outlet 45.

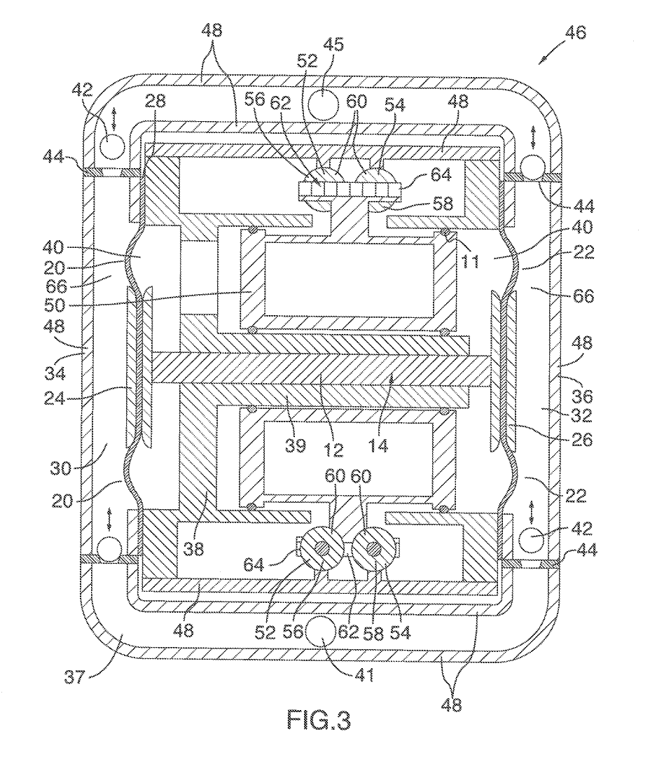

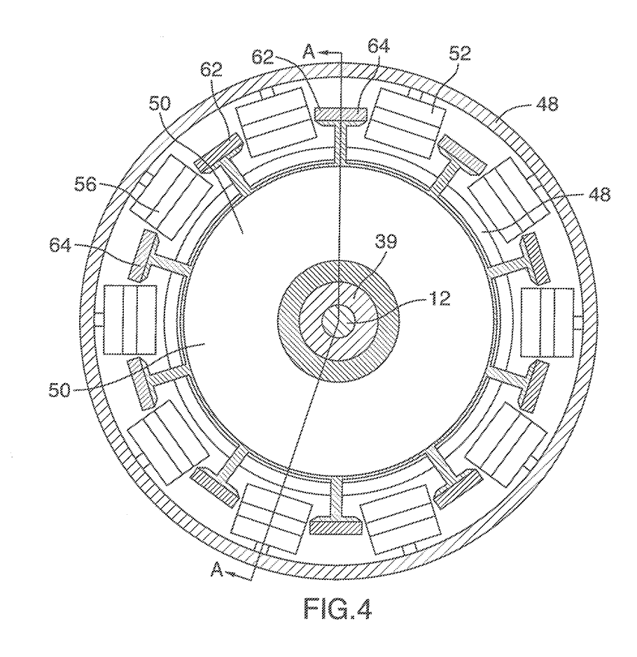

In FIGS. 3 and 4, there is shown a second embodiment of the double diaphragm pump of the present invention. The same reference numerals are used in FIGS. 3 and 4 for those components that are identical, or very similar, to the components of the double diaphragm pump 2. A double diaphragm pump 46 has a housing 48 with a piston assembly 50 surrounding the shaft 12.

The shaft support 38 is preferably a sleeve 39 that is anchored to the housing 4, 48 at one end, as shown in FIGS. 1, 2 and 3. The passage 37 extends through a suction manifold portion of the housing and the passage 43 extends through the discharge manifold portion of the housing. The suction manifold extends between the two check valves at a lower end of the housing and the discharge manifold extends between the two check valves at an upper end of the housing of each embodiment.

The piston assembly 50 has two substantially parallel rows 52,54 of a plurality of spaced-apart first electromagnetic cons 56,58, respectively, that are fixedly mounted in the housing 48. The rows 52,54 extend around the shaft 14 and the first electromagnetic cons 56, in row 52, are immediately adjacent to and form a pair 60 with the first electromagnetic coils 58 in row 54. Sets 62 of a plurality of permanent magnets 64 extend around the shaft, the sets being affixed to the piston assembly 50. Each set 62 contains a plurality of permanent magnets 64 and one set 62 is located between adjacent pairs 60. The number of sets 62 is equal to the number of pairs 60. Each set 62 contains a plurality of permanent magnets and the permanent magnets within each set are oriented to have an opposite polarity to immediately adjacent permanent magnets within the set and are spaced slightly apart from immediately adjacent permanent magnets. The shaft assembly 12 is centrally located in FIG. 3 with diaphragms 20, 22 and disks 24, 26 being equidistant from the adjacent outer wall of the housing 48. When the pump 46 is operating, one of the pumping chambers 30 or 32 is always under compression and the other pumping chamber 32 or 30 respectively is always under suction, as the piston assembly 12 is reciprocating toward one side and then other.

The electromagnetic coils 56,58 are electrically connected to alternating polarity voltage, thereby causing the sets 62 to simultaneously move longitudinally relative to the electromagnetic coils in one direction for one stroke and in an opposite direction for another stroke, thereby causing the piston assembly to reciprocate within the housing between the two pumping chambers 30,32. As with the first embodiment, the reciprocating piston assembly 50 of the second embodiment exerts pressure on the buffer fluid 40, which in turn causes the shaft assembly 12 to reciprocate between the pumping chambers. There are inletldischarge ports 42,44, seals and check valves to facilitate pumping action. As shown in FIGS. 3 and 4, the electromagnetic coils 56,58 are arranged in two substantially parallel rows 52,54, respectively. Both the electromagnetic coils 56,58 and the sets 62 of permanent magnets 64 extend around the shaft 14.

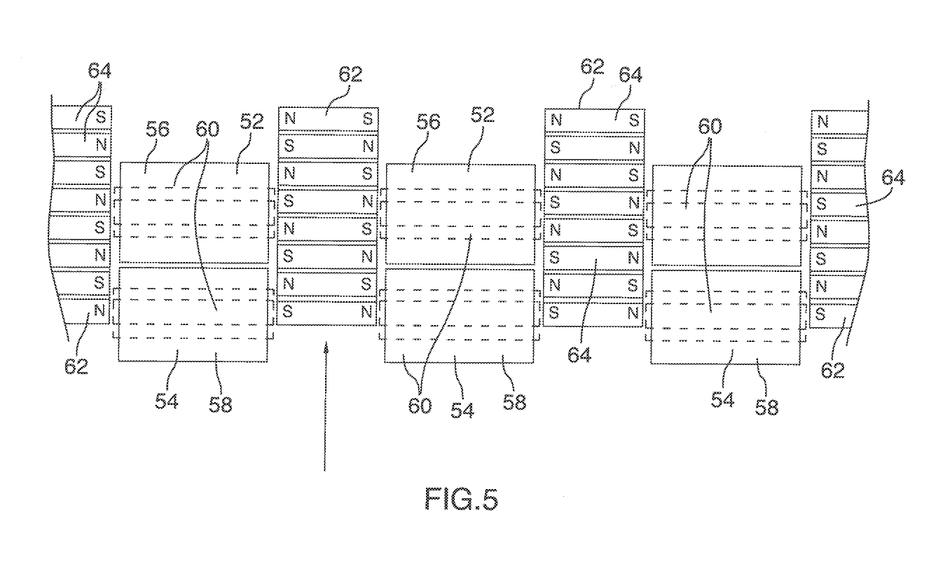

In FIG. 5, there is shown a schematic top view of the sets 62 of permanent magnets 64,The curvature in the spacial relationship between the sets 62 and the electromagnetic coils 56,58 shown in FIG. 4, is not captured in FIG. 5. FIG. 5 is drawn as though the sets 62 and coils 56,58 were located substantially in the same plane. The same reference numerals are used in FIG. 5 as those used in FIGS. 3 and 4, to identify those components that are identical. The sets move longitudinally in one direction and then in the opposite direction relative to the magnetic coils, with each direction of movement representing one stroke of the pump. Preferably, the power source for the second embodiment is an AC voltage that provides an AC current to the electromagnetic coils 56,58 causing the sets 62 and the piston assembly 50 to move in one direction for one stroke. When the sequence of polarity changes at the end of each stroke, the sets 62 and the piston assembly 50 move in an opposite direction for one stroke. The piston assembly 50 reciprocates, causing pressure to be placed on the buffer fluid 40, which in turn causes the shaft assembly 12 to reciprocate.

While it is preferable to have the electromagnetic coils affixed to the housing and the permanent magnets affixed to the piston assembly, as a variation, the electromagnetic coils can be affixed to the piston assembly and the permanent magnets can be affixed to the housing. Further, while it is preferable to use electromagnetic coils and permanent magnets as described above for the first and second embodiments, as a further variation, the permanent magnets can be replaced by additional electromagnetic coils that are electrically connected to function as permanent magnets.

Preferably, the double diaphragm pumps of the present invention are used for pumping liquids 66. The liquids can contain some solids or particulates. The pumping chambers of the double diaphragm pump are preferably fluidly connected to one another.

The drive of the second embodiment is a tubular/linear motor. The buffer fluid hydraulically reciprocates the diaphragms in a manner that is gentler than it would be if the shaft and diaphragm assemblies were caused to reciprocate directly by electromagnetic force.

The permanent magnets of each set of the second embodiment are spaced-apart slightly from one another.

Some of the advantages of the pumps of the present invention are as follows. The double diaphragm pumps can run dry, are self-priming, and can be operated with variable flow and with variable pressure. No seals are required except for seals to ensure that the buffer fluid does not enter the interior of the piston assembly. The pumps can be used to handle viscous liquids, liquids containing solids and/or chemicals. The pumps of the present invention are not dependent on compressed air, which can be very expensive. Metering can be provided by the use of spring check valves and the pumps can be designed for submersible use. Pumps can also be used for batching, pH balance or blending and can be controlled remotely, for example, by a Smart Phone. Also, data collection or tracking can be utilized with the pumps for inventory control, quality control, production reports and monitoring. The pumps can handle many industry-specific process functions which can be automated and monitored remotely. For example, the voltage level at which the pump operates, the cycle rate, or turning the power on/off can be automated and monitored remotely. The pumps can be used in waste water treatment involving the dosing of chemicals such as chlorine, flocculents, acids or caustics using pH, free chlorine or ORP controllers and/or a flow meter. The pumps are positive displacement in that a given volume of pumpage is discharged with each stroke or fraction of a stroke. Accurate control of the dispensed volume can therefore be obtained for batching or metering. Batching can normally be achieved with the standard ball checks and a cycle monitor that can be pre-set and countdown to shutoff. Metering requires a higher degree of accuracy than batching and can be better attained with spring-loaded poppet style or polymeric dihedral style valving. The linear motor design can be controlled down to ⅕ of a stroke, since each change in polarity moves the piston ⅕ of a full stroke. A cycle or stroke monitor as used for batching or a cycle rate controller which provides accurate dosing. The linear motor design shown in FIG. 3 is particularly useful for metering because of the stroke control capability.

The double diaphragm pumps shown in the drawings have dual manifolds.

Fasteners to fasten the components together have not been shown in the drawings and will be readily apparent to those skilled in the art. The components described as the housing will be fastened together, preferably by volting as volting enables the components to be separated for repair purposes. All of the seals are not shown in the drawings and will be readily apparent to those skilled in the art.

The positive displacement feature, with optional weighted check valves, allows the pumps to handle high viscosity and/or specific gravity fluids efficiently. Changing to flap style check valves allows the pumps to handle slurries with solids up to the size of the inlet port. A two phase AC voltage that is 90° out of phase can be used to provide the alternating polarity voltage.

The pump drive section can be bolted in place with existing manufacturer's components. These components can be made from a range of various metals, plastics and elastomers, Components to meet the FDA and/or dairy standards for the food industry are also available.

Powdered solids can sometimes be handled with custom modifications to the pumping chamber and valve housings to keep the powder fluidized. Electronic and computer processing can also be used to provide remote control and monitoring.

Variations with the scope of the claims will be readily apparent to those skilled in the art.

We claim:

1. A double diaphragm pump comprising a shaft assembly located in a housing, the shaft assembly having a shaft with two ends and two diaphragms, there being one diaphragm at each end, a pumping chamber being located outside of each diaphragm, there being two pumping chambers, the pumping chambers being fluidly connected to one another and each pumping chamber having at least one opening to receive and discharge pumpage, the shaft assembly being slidable from side to side of the pump from one pumping chamber to the other, a first electromagnetic coil being fixedly mounted within the housing and being located within a piston assembly between two additional magnets, during operation the additional magnets being oriented with like polarity facing the first electromagnetic coil, the additional magnets being affixed to the piston assembly, one of the additional magnets always being spaced apart from the first electromagnetic coil, buffer fluid filling a void in the housing between the shaft assembly and the piston assembly, the piston assembly being sealed to prevent buffer fluid from contacting the first electromagnetic coil and the additional magnets, the first electromagnetic coil electrically connected to repeatedly reverse polarity to alternately attract one additional magnet and repel the other additional magnet to cause the piston assembly to reciprocate with the additional magnets as the first electromagnetic coil remains fixed, the reciprocation of the piston assembly exerting pressure on the buffer fluid to cause the shaft assembly to reciprocate, the shaft assembly alternately exerting pressure on one pumping chamber and releasing pressure on the other pumping chamber, with check valves, seals and inlet/discharge ports to facilitate pumping action.

2. The diaphragm pump as claimed in claim 1 wherein the two additional magnets are two permanent magnets.

3. The double diaphragm pump as claimed in claim 1 wherein the electromagnetic magnetic coil is a first electromagnetic coil and the two additional magnets are second and third electromagnetic coils.

4. The double diaphragm pump as claimed in claim 2 wherein the pumpage is a liquid.

5. The double diaphragm pump as claimed in claim 2 wherein the first electromagnetic coil and the permanent magnets extend around the piston.

6. The double diaphragm pump as claimed in claim 2 wherein the first electromagnetic coil is two substantially parallel rows of a plurality of spaced apart first electromagnetic coils fixedly mounted in the housing, the rows extending around the shaft, the first electromagnetic coils in one row being immediately adjacent to and paired with of the first electromagnetic coils in the other row, the two permanent magnets being a row of a plurality of spaced apart permanent magnets being fixedly mounted in the piston assembly, each permanent magnet of the plurality of permanent magnets alternating with the pairs of first electromagnetic coils and extending around the piston, each permanent magnet having one pole facing one first electromagnetic coil in one row and another pole facing one first electromagnetic coil in the other row, the piston assembly reciprocating by an alternating change in polarity of the paired first electromagnetic coils.

7. The double diaphragm pump as claimed in claim 1 wherein there are two rows of a plurality of electromagnetic coils surrounding the shaft, the two rows being spaced from one another and being parallel to one another with each electromagnetic coil in one row being adjacent to an electromagnetic coil in the other row, the adjacent electromagnetic coils in the two rows forming a pair of electromagnetic coils; a plurality of sets of second electromagnetic coils surrounding said shaft, each set having a plurality of second electromagnetic coils that are slightly spaced apart from one another; each electromagnetic coil of the plurality of second electromagnetic coils of each set being arranged so that adjacent second electromagnetic coils within each set have opposing polarity and the plurality of second electromagnetic coils in alternating sets have opposing polarity to each adjacent set, there being one set of second electromagnetic coils located between each pair of first electromagnetic coils;

8. A double diaphragm pump as claimed in claim 2 wherein there are two rows of a plurality of electromagnetic coils surrounding the shaft, the two rows being spaced apart from one another and being parallel to one another with each electromagnetic coil in one row being adjacent to an electromagnetic coil in the other row, the adjacent electromagnetic coils in the two rows forming a pair of electromagnetic coils;
a plurality of sets of permanent magnets surrounding said shaft, each set having a plurality of permanent magnets that are slightly spaced apart from one another;
each permanent magnet of each set being arranged so that adjacent permanent magnets within each set have opposing polarity and the plurality of sets have opposing polarity to each adjacent set, there being one set of permanent magnets located between each pair of electromagnetic coils;

9. A double diaphragm pump for pumping liquids, the pump comprising:
(a) a shaft assembly mounted in a housing, the shaft assembly having a shaft with two ends and two diaphragms, there being one diaphragm mounted at each end of the two ends of the shaft;
(b) two pumping chambers located within the housing outside of each diaphragm;
(c) a piston assembly surrounding the shaft, the shaft assembly being slidable between the two pumping chambers and the piston assembly being slidable in the same direction as the shaft assembly;
(d) a void between the shaft assembly and the piston assembly being filled with buffer fluid;
(e) a combination of electromagnetic coils and permanent magnets arranged to form a tubular linear motor that is connected to a power source to cause the electromagnetic coils to repeatedly alternate polarity to cause the piston assembly to reciprocate between the two pumping chambers;
(f) the reciprocating piston assembly exerting pressure on the buffer fluid, which in turn causes the shaft assembly to reciprocate; and
(g) inlet/discharge ports and check valves to facilitate pumping action.

10. A method of operating a double diaphragm pump for pumping liquids, the pump having:
(a) a shaft assembly mounted in a housing, the shaft assembly having a shaft with two ends and two diaphragms, there being one diaphragm mounted at each end of the two ends of the shaft;
(b) two pumping chambers located within the housing outside of each diaphragm;
(c) a piston assembly surrounding the shaft, the shaft assembly being slidable between the two pumping chambers and the piston assembly being slidable in the same direction as the shaft assembly;
(d) a void between the shaft assembly and the piston assembly being filled with buffer fluid;
(e) a combination of electromagnetic coils and permanent magnets arranged to form a tubular linear motor that is connected to a power source to cause the electromagnetic coils to repeatedly alternate polarity to cause the piston assembly to reciprocate within the housing between the two pumping chambers;
(f) the reciprocating piston assembly exerting pressure on the buffer fluid, which in turn causes the shaft assembly to reciprocate;
(g) inlet/discharge ports and check valves to facilitate pumping action;
(h) the method comprising connecting the tubular linear motor to a power source to cause the electromagnetic coils to repeatedly alternate polarity, thereby causing some of the permanent magnetics to be alternately attracted and repelled by the electromagnetic coils and causing the piston assembly to reciprocate within the housing between the two pumping chambers, the piston assembly in turn causing the buffer fluid to cause the piston assembly to reciprocate.
